(19) United States
(12) Patent Application Publication
(10) Pub. No.: US 2016/0077942 A1
(43) Pub. Date: Mar. 17, 2016

(54) STORAGE SYSTEM AND TEST METHOD FOR TESTING PCI EXPRESS INTERFACE

(71) Applicant: Celestica Technology Consultancy (Shanghai) Co., Ltd., Shanghai (CN)

(72) Inventor: Xue-Qin HE, Shanghai (CN)

(73) Assignee: Celestica Technology Consultancy (Shanghai) Co., Ltd., Shanghai (CN)

(21) Appl. No.: 14/485,607

(22) Filed: Sep. 12, 2014

(51) Int. Cl. G06F 11/22; G06F 13/42; G06F 11/30; G06F 13/28

(52) U.S. Cl. CPC G06F 11/221; G06F 13/28; G06F 13/4221; G06F 11/3027; G06F 11/3034

(57) ABSTRACT

Provided is a storage system and a test method for a testing Peripheral Component Interconnect Express (PCI Express) interface. The storage system of the present invention includes a plurality of DMA memory units storing test data, a data processing unit connected to the plurality of DMA memory units, wherein a predetermined amount of data is transmitted at least once from a first processing (such as an SAS control chip) to the plurality of DMA memory units through a PCI Express interface and the data processing unit, transmission information is generated and recorded during data transmission, and the transmission information is outputted by the data processing unit while data transmission is completed or an interrupt is generated due to an error occurred during data transmission, and a test unit testing the PCI Express interface based on the transmission information outputted by the data processing unit.

### BACKGROUND OF THE INVENTION

1. Field of the Invention

The present invention relates generally to bus testing, and more particularly, to a storage system and a test method for testing a Peripheral Component Interconnect Express (PCI Express) interface.

2. The Prior Arts

A storage system generally consists of various storage devices storing programs and data, a control unit and a device (hardware)/algorithm (software) managing information transmission. With the rapid development of Internet applications, demands on storage system performance are increased. The storage system communicates with external devices over a PCI Express interface. Accordingly, a match of the PCI Express interface and related hardware and their performance may affect the storage system performance. Therefore, the PCI Express interface is generally tested after completion of the storage system design.

The current test equipment includes a data generator and a test analyzer. The data generator generates a large amount of data through the PCI Express interface of the storage system. Subsequently, the test analyzer may receive data from the PCI Express interface, and analyze the received data. Then, the analyzed results may be provided and illustrated.

The hardware structure of the above test equipment is complicated and costly. In addition, unpacking the storage system is required to perform testing, thereby enabling the test procedure to be complicated. Therefore, in order to achieve low cost and a simplified storage system, there is a need for a solution that overcomes the aforementioned prior-art issues.

### SUMMARY OF THE INVENTION

In light of the foregoing drawbacks, an objective of the present invention is to provide a storage system a test method for testing a PCI Express interface, thereby overcoming the problems that the storage system testing in prior art is too complicated.

For achieving the foregoing objective, the present invention provides a storage system for testing a PCI Express interface, including a plurality of DMA memory units storing data for testing, a data processing unit connected to the plurality of DMA memory units, wherein a predetermined amount of data is transmitted at least once from a first processing unit to the plurality of DMA memory units through a PCI Express interface and the data processing unit, transmission information is generated and recorded during data transmission, and the transmission information is outputted by the data processing unit while data transmission is completed or an interrupt is generated due to an error occurred during data transmission, and a test unit testing the PCI Express interface based on the transmission information outputted by the data processing unit.

Preferably, the plurality of DMA memory units is a circular queue used to circularly store amounts of data.

Preferably, the data processing unit outputs recorded transmission information to the test unit while a predetermined interrupt is generated.

Preferably, the data processing outputs new recorded transmission information to the test unit while data transmission is completed or interrupts are generated due to errors occurred during data transmission.

Preferably, the transmission information includes a data amount of each of data, a time required to transmit all the data, amounts of transmitted data and error information occurred during data transmission performed by the data processing unit.

Preferably, the data processing unit includes a multi-core processor, a DMA controller and a register, wherein the register stores the error information generated during data transmission.

Preferably, the PCI Express interface includes functions of bandwidth, delay and stability.

According to the present invention, the present invention further provides a test method for testing a PCI Express interface, used in a storage system. The storage system includes a plurality of DMA memory units, a PCI Express interface and a first processing unit connected to the PCI Express interface. The test method of the present invention includes the steps of (1) transmitting a predetermined amount of data at least once from the first processing unit to the plurality of DMA memory units through the PCI Express interface and the data processing unit, and generating and recording transmission information during data transmission, (2) storing the transmission information while data transmission is completed or an interrupt is generated due to an error occurred during data transmission, and (3) testing the PCI Express interface based on the stored transmission information.

Preferably, while data transmission is completed or an interrupt is generated due to an error occurred during data transmission, the step of storing the transmission information further includes a step of storing recorded transmission information while a predetermined interrupt is generated.

Preferably, while data transmission is completed or an interrupt is generated due to an error occurred during data transmission, the step of storing the transmission information further includes a step of storing new recorded transmission information while data transmission is completed or interrupts are generated due to errors occurred during data transmission.

Preferably, the transmission information includes a data amount of each of data, a time required to transmit all the data, amounts of transmitted data and error information occurred during data transmission performed by the data processing unit.

Preferably, the PCI Express interface includes functions of bandwidth, delay and stability.

As described above, the storage system and the test method for testing a PCI Express interface bring about the following technical effects. A large amount of test data may be generated by software in the PCI Express interface. As such, the cost of test equipment can be effectively reduced due to reducing the use of hardware for generating data. Additionally, since the recorded transmission information is outputted to the test unit while data transmission is completed or interrupts are generated due to errors occurred during data transmission, the recorded transmission information can be accurately transmitted to the test unit so as to enable the test unit to effectively obtain test results. Moreover, transmitting the transmission information to the test unit while an interrupt is generated each time may effectively decrease the number of registers. Further, the transmission time may be reduced since a small amount of transmission information is transmitted while an interrupt is generated each time.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram illustrating a storage system for testing a Peripheral Component Interconnect Express (PCT Express) interface according to the present invention; and

FIG. 2 is a flow chart showing a test method for testing the PCI Express interface according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

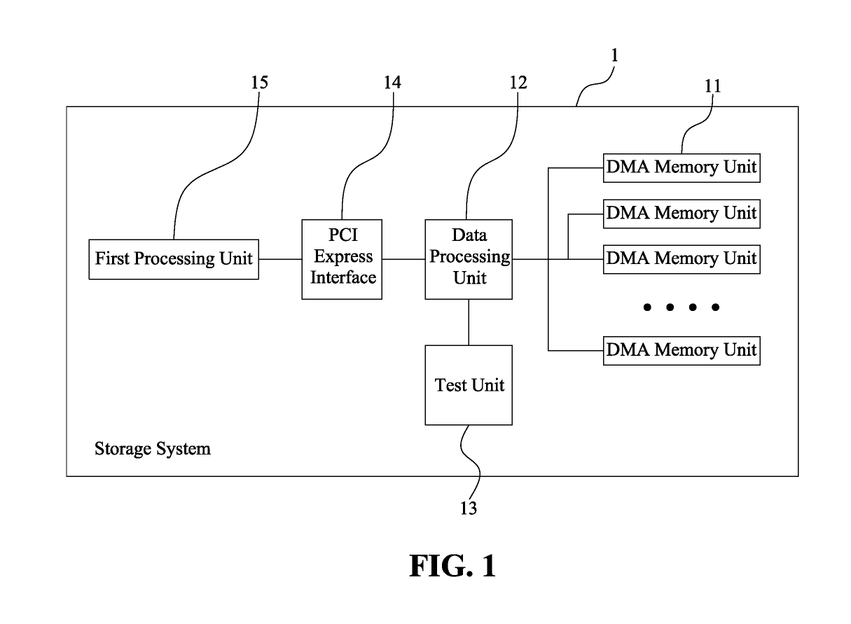

With regard to FIG. 1, the drawings showing embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

The present invention provides a storage system for testing a Peripheral Component Interconnect Express (PCI Express) interface. The storage system may be a specific information system for data backups and disaster recovery, and is used to store a large amount of data through high-speed Internet access.

Referring to FIG. 1, the storage system 1 includes a PCI Express interface 14 and a first processing unit 15. According to the present invention, the first processing unit, such as a storage control chip, is a core processing unit in the storage system 1.

The storage system 1 further includes a Direct Memory Access (DMA) memory unit 11, a data processing unit 12 and a test unit 13.

Moreover, the DMA memory unit 11 may be plural, and is used to store test data.

According to the present invention, the DMA memory unit 11 stores one or more data by a queue or a stack. A data amount of each of data may be the same or different. Preferably, the DMA memory unit 11 may be a circular queue used to circularly store amounts of data. For example, the memory having a circular queue is 2 MB. A data amount of each of data is limited to 2⁷ bytes. In the circular queue, 2¹⁴ entities are kept in a circular manner to store data. The number of DMA memory units 11 may be selected based on a bit field of the PCI Express interface 14 and the number of tests. For example, the bit field of the PCI Express interface 14 to be tested is ×8. In order to meet the test requirement of multiple transmissions, 64 DMA memory units may be selected, and each of the DMA memory units may have 2 MB.

As shown in FIG. 1, the data processing unit 12 is connected to the plurality of DMA memory units 11. A predetermined amount of data is transmitted at least once from the first processing unit 15 to the plurality of DMA memory units 11 through the PCI Express interface 14 and the data processing unit 12. Transmission information is generated and recorded during data transmission, and the transmission information is outputted by the data processing unit while data transmission is completed or an interrupt is generated due to an error occurred during data transmission. The transmission information includes generated information during data transmission through the PCI Express interface 14, but is not limited to a data amount of each of data, a time required to transmit all the data, amount of transmitted data and error information occurred during data transmission performed by the data processing unit. According to the present invention, the data processing unit 12 preferably includes a multi-core processor and a motherboard or a chip with respect to a DMA controller. The data processing unit 12 further includes a register. The register is inside the first processing unit for storing error information generated during data transmission. There may be one or more registers that stores error information according to the present invention.

In other words, a predetermined amount of data is transmitted at least once from the first processing unit 15 to the plurality of DMA memory units through the PCI Express interface 14 and the data processing unit 12 based on the predetermined number of transmissions. Transmission information is generated and recorded during data transmission. Additionally, the recorded transmission information is outputted to the test unit 13 by the data processing unit while data transmission is completed or interrupts are generated due to errors occurred during data transmission. After that, a new transmission or an uncompleted transmission is continued to perform. The data processing unit 12 may read data from the plurality of DMA memory units 11 or write data to the plurality of DMA memory units 11 by using DMA.

Preferably, since the speed of reading data from the plurality of DMA memory units 11 is faster than that of writing data to the plurality of DMA memory units, in order to reduce interference that data of the plurality of DMA memory units is accessed (read/write operations) through the PCI Express interface, the data processing unit 12 reads a predetermined amount of data from at least one of the plurality of DMA memory units 11, and the predetermined amount of data is transmitted to the first processing unit 15 through the PCI Express interface 14. The generated transmission information is recorded during data transmission. As such, the recorded transmission information is transmitted to the test unit 13 while a predetermined interrupt is generated.

For example, if two transmission operations are performed, the recorded transmission information is outputted while the second transmission operation is completed or an interrupt is generated during data transmission. In addition, the first transmission operation is performed as follows. The data processing unit 12 reads a predetermined amount of data from each of the plurality of DMA memory units 11 by using DMA. The read data is transmitted to the first processing unit 15 through the PCI Express interface 14. Moreover, the data processing unit 12 records data amounts of each of data. The transmission information with regard to the data amounts of each of data is transmitted while the first transmission operation is completed or an interrupt is generated. Subsequently, the second transmission operation is performed as follows. The data processing unit 12 continues to read a predetermined amount of data from each of the plurality of DMA memory units 11. The read data is transmitted to the first processing unit 15 through the PCI Express interface 14. The transmission information is continued to record during the second transmission operation. Accordingly, the recorded transmission information regarding two transmission operations is outputted while the second transmission operation is completed or an interrupt is generated.

More preferably, the data processing unit 12 transmits new recorded transmission information to the test unit 13 based on each of interrupts.

For example, based on a first interrupt, the data processing unit 12 transmits the transmission information with regard to amounts of data, a data amount of each of data and a time required to complete transmission to the test unit 13 based on the first interrupt generated during data transmission. Subsequently, the data processing unit 12 starts second transmission, but a second interrupt is generated due to an error occurred. The data processing unit 12 transmits the transmission information with regard to amounts of data, a data amount of each of data and error information during a second transmission to the test unit 13 based on the second interrupt.

According to the present invention, the test unit 13 may test the PCI Express interface in accordance with the transmission information outputted by the data processing unit 12. However, the functions of the PCI Express interface 14 include bandwidth, delay and stability, but are not limited to those.

In other words, the test unit 13 may calculate the amount of data transmitted per unit of time based on the received data amount of each of data, the amounts of all the data and a time required to transmit all the data. According, the bandwidth of the PCI Express interface is tested by the test unit 13. In addition, the test unit 13 may compare the amount of the received error information with a predetermined threshold. If the amount of the received error information is greater than the predetermined threshold, the PCI Express interface is determined to be unstable.

For example, the transmission information received by the test unit 13 may a complete transmission record. The transmission performance of the PCI Express interface may be obtained in accordance with the amount of transmission information and the time-consuming calculation.

Moreover, the data processing unit 12 may transmit new recorded transmission information to the test unit 13 during each of interrupts. When transmission of all the data is completed, the test unit 13 may calculate the amount of data transmitted per unit of time based on the received data amount of data, the amounts of the data and a time required to transmit all the data. Therefore, the bandwidth of the PCI Express interface is tested by the test unit 13. Further, the test unit 13 may compare the amount of the received error information with a predetermined threshold. If the amount of the received error information is greater than the predetermined threshold, the PCI Express interface is determined to be unstable.

According to the present invention, the operation of the storage system 1 is performed as follows.

The data processing unit 12 reads data from each of the plurality of DMA memory units 11 by using DMA. The read data is transmitted to the first processing unit 15 through the PCI Express interface 14 to complete data transmission. The data processing unit 12 generates an interrupt while the data transmission is completed or error information is occurred. The recorded transmission information is transmitted to the test unit 13 based on the interrupt. Subsequently, a new data transmission will be continued or the previous data transmission will be continued. The above steps are repeated until the predetermined number of transmissions is achieved. The test unit 13 may start to analyze all the transmission information after the test unit 13 receives a final set of transmission information from the data processing unit 12. If the transmission information includes error information, it will be determined whether the PCI Express interface is stable in accordance with the types and amounts of error information. If the transmission information does not include error information, the bandwidth of the PCI Express interface 14 will be tested based on a data amount of each of data, amounts of all the data and a time required to transmit all the data.

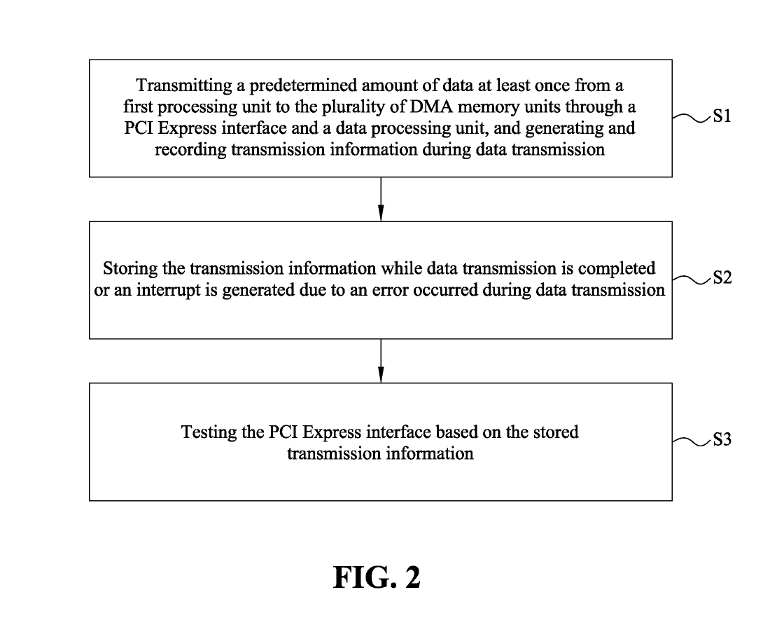

As shown in FIG. 2, the present invention also provides a test method for testing a PCI Express interface. The test method is performed by a test system. The test system is installed in the storage system. Moreover, the storage system includes a plurality of DMA memory units, a PCI Express interface and a first processing unit connected to the PCI Express interface. Accordingly, the test method of the present invention includes the following steps.

In step S1, a predetermined amount of data is transmitted at least once from the first processing unit to the plurality of DMA memory units through the PCI Express interface and the data processing unit. Additionally, transmission information is generated and recorded during data transmission. According to the present invention, the transmission information includes a data amount of each of data, a time required to transmit all the data, amounts of transmitted data and error information occurred during data transmission performed by the data processing unit. However, the transmission information is not limited to those.

In other words, the test system transmits a predetermined amount of data from the first processing unit to the plurality of DMA memory units at least once in accordance with a predetermined number of transmissions. The transmission information is recorded during each of data transmissions.

Preferably, since the speed of reading data from the plurality of DMA memory units is faster than that of writing data to the plurality of DMA memory units, and in order to reduce interference that data of the plurality of DMA memory units is accessed (read/write operations) through the PCI Express interface, a predetermined amount of data is transmitted at least once from the first processing unit to the plurality of DMA memory units through the PCI Express interface and the data processing unit. The transmission information is recorded during each of data transmissions.

Then, proceed to step S2 during an interrupt generated by the test system while each of transmissions is completed or an interrupt is generated during each of data transmissions.

In step S2, the transmission information is stored while data transmission is completed or an interrupt is generated due to an error occurred during data transmission.

That is to say, an interrupt is generated while data transmission is completed and an error is occurred during data transmission. The test system may store the recorded transmission information while an interrupt is generated. Start a new transmission, continue the uncompleted transmission or proceed to step S3 after storing the recorded transmission information.

For example, if two transmission operations are performed, the recorded transmission information is outputted while the second transmission operation is completed or an interrupt is generated during data transmission. In addition, the first transmission operation is performed as follows. The data processing unit reads a predetermined amount A of data from each of the plurality of DMA memory units by using DMA. The read data is transmitted to the first processing unit through the PCI Express interface. Moreover, the data processing unit records data amounts of each of data. The transmission information with regard to the data amounts of each of data is transmitted while the first transmission operation is completed or an interrupt is generated. Subsequently, the second transmission operation is performed as follows. The data processing unit continues to read a predetermined amount B of data from each of the plurality of DMA memory units. The read data is transmitted to the first processing unit through the PCI Express interface. The transmission information is continued to record during the second transmission operation. Accordingly, the recorded transmission information regarding two transmission operations is stored while the second transmission operation is completed or an interrupt is generated.

Preferably, step S2 further include a step of storing new recorded transmission information based on each of interrupts in the test system.

For example, based on a first interrupt, the test system stores the transmission information with regard to amounts of data, a data amount of each of data and a time required to complete transmission based on the first interrupt generated during data transmission. Subsequently, the data processing unit starts second transmission, but a second interrupt is generated due to an error occurred. The test system stores the transmission information with regard to amounts of data, a data amount of each of data and error information during second transmission based on the second interrupt.

In step S3, the PCI Express interface is tested based on the stored transmission information. Additionally, the functions of the PCI Express interface include bandwidth, delay and stability, but are not limited to those.

In other words, the test unit 13 may calculate the amount of data transmitted per unit of time based on the received data amount of each of data, the amounts of all the data and a time required to transmit all the data. According, the bandwidth of the PCI Express interface is tested by the test unit 13. In addition, the test unit 13 may compare the amount of the received error information with a predetermined threshold. If the amount of the received error information is greater than the predetermined threshold, the PCI Express interface is determined to be unstable.

For example, the transmission information received by the test unit 13 is a complete transmission record. The transmission performance of the PCI Express interface may be obtained in accordance with the amount of transmission information and the time-consuming calculation.

Moreover, the data processing unit 12 may transmit new recorded transmission information to the test unit 13 during each of interrupts. When transmission of all the data is completed, the test unit 13 may calculate the amount of data transmitted per unit of time based on the received data amount of data, the amounts of the data and a time required to transmit all the data. Therefore, the bandwidth of the PCI Express interface is tested by the test unit 13. Further, the test unit 13 may compare the amount of the received error information with a predetermined threshold. If the amount of the received error information is greater than the predetermined threshold, the PCI Express interface is determined to be unstable.

As described above, the storage system and the test method for testing a PCI Express interface bring about the following technical effects. A large amount of test data may be generated by software through the PCI Express interface. As such, the cost of test equipment can be effectively reduced due to reducing the use of hardware for generating data. Additionally, since the recorded transmission information is outputted to the test unit while data transmission is completed or interrupts are generated due to errors occurred during data transmission, the recorded transmission information can be accurately transmitted to the test unit so as to enable the test unit to effectively obtain test results. Moreover, transmitting the transmission information to the test unit while an interrupt is generated each time may effectively decrease the number of registers. Further, the transmission time may be reduced since a small amount of transmission information is transmitted while an interrupt is generated each time. In addition, a large amount of test data may be rapidly generated through the PCI Express interface while data of each of the plurality of DMA memory units is read and transmitted to the first processing unit. Besides, DMA allows the test system to access the plurality of DMA memory units independently of the central processing unit (CPU). Accordingly, the large amount of data may be generated through the PCI Express interface at a high reading speed. Moreover, a few hardware units are used in the test system, thereby reducing costs of hardware. Further, large amounts of data may also be transmitted by a multi-core processor over a PCI Express interface bus, thereby achieving testing of the PCI Express interface. Therefore, the present effectively overcomes the aforementioned prior-art issues, and has industrial applicability.

The above exemplary embodiment describes the principle and effect of the present invention, but is not limited to the present invention. It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A storage system for testing a Peripheral Component Interconnect Express (PCI Express) interface, comprising:
a plurality of DMA memory units storing data for testing;
a data processing unit connected to the plurality of DMA memory units,
wherein a predetermined amount of data is transmitted at least once from a first processing unit to the plurality of DMA memory units through a PCI Express interface and the data processing unit, transmission information is generated and recorded during data transmission, and the transmission information is outputted by the data processing unit while data transmission is completed or an interrupt is generated due to an error occurred during data transmission; and
a test unit testing the PCI Express interface based on the transmission information outputted by the data processing unit.

2. The storage system according to claim 1, wherein the plurality of DMA memory units is a circular queue used to circularly store amounts of data.

3. The storage system according to claim 1, wherein the data processing unit outputs recorded transmission information to the test unit while a predetermined interrupt is generated.

4. The storage system according to claim 1, wherein the data processing unit outputs new recorded transmission information to the test unit while data transmission is completed or interrupts are generated due to errors occurred during data transmission.

5. The storage system according to claim 1, wherein the transmission information comprises a data amount of each of data, a time required to transmit all the data, amounts of transmitted data and error information occurred during data transmission performed by the data processing unit.

6. The storage system according to claim 5, wherein the data processing unit comprises a multi-core processor, a DMA controller and a register, wherein the register stores the error information generated during data transmission.

7. The storage system according to claim 1, wherein the PCI Express interface comprises functions of bandwidth, delay and stability.

8. A test method for testing a Peripheral Component Interconnect Express (PCI Express) interface, used in a storage system, wherein the storage system comprises a plurality of DMA memory units, a PCI Express interface and a first processing unit connected to the PCI Express interface, the test method comprising the steps of:
transmitting a predetermined amount of data at least once from the first processing unit to the plurality of DMA memory units through the PCI Express interface and the data processing unit, and generating and recording transmission information during data transmission;
storing the transmission information while data transmission is completed or an interrupt is generated due to an error occurred during data transmission; and
testing the PCI Express interface based on the stored transmission information.

9. The test method according to claim 8, wherein while data transmission is completed or an interrupt is generated due to an error occurred during data transmission, the step of storing the transmission information further comprises storing recorded transmission information while a predetermined interrupt is generated.

10. The test method according to claim 8, wherein while data transmission is completed or an interrupt is generated due to an error occurred during data transmission, the step of storing the transmission information further comprises storing new recorded transmission information while data transmission is completed or interrupts are generated due to errors occurred during data transmission.

11. The test method according to claim 8, wherein the transmission information comprises a data amount of each of data, a time required to transmit all the data, amounts of transmitted data and error information occurred during data transmission performed by the data processing unit.

12. The test method according to claim 8, wherein the PCI Express interface comprise functions of bandwidth, delay and stability.
